(19) United States
(12) Patent Application Publication
(10) Pub. No.: US 2026/0368873 A1
(43) Pub. Date: Nov. 19, 2026

(54) AUTOMATED IMAGE DETECTION AND EXTRACTION FOR TESTING SYSTEMS OF VEHICLES

(71) Applicant: GM GLOBAL TECHNOLOGY OPERATIONS LLC, DETROIT, MI (US)

(72) Inventor: Vishranthi Nairi, Northville, MI (US)

(21) Appl. No.: 19/206,663

(22) Filed: May 13, 2025

(51) Int. Cl. G06T 7/00; B60K 35/28; G06F 9/451; G06F 16/23; G06T 7/11

(52) U.S. Cl. CPC G06T 7/0002; B60K 35/28; G06F 9/451; G06F 16/23; G06T 7/11

(57) ABSTRACT

Examples described herein provide a method that includes receiving an image of a user interface of a system of a vehicle. The method further includes identifying input regions on the image of the user interface, the input regions to receive a user input of a user input type. The method further includes for each of the input regions of the image of the user interface, generating an input region image and location information. The method further includes performing a validation test on the user interface of the system of the vehicle using the input region image and the location information for each of the input regions. The method further includes updating the user interface of the system of the vehicle responsive to a result of the validation test.

### BACKGROUND

The subject disclosure relates to vehicles, and in particular to automated image detection and extraction for testing systems of vehicles.

Modern vehicles (e.g., a car, a motorcycle, a boat, or any other type of automobile) may be equipped with various vehicle systems, such as climate control systems, infotainment systems, and/or the like, with which a user interacts. One way a user can interact with such systems is via a user interface displayed on a touch screen display within the vehicle.

Vehicle system testing, particularly for in-vehicle displays, ensures that user interfaces (UIs) are both functional and intuitive. This process involves evaluating how well a vehicle system responds to user inputs, such as touch, voice commands, or physical controls, while checking for accuracy, responsiveness, and system stability. Functional testing verifies that each feature—from navigation and climate control to entertainment and safety alerts—works as intended under various conditions. Testers simulate real-world scenarios, like sudden power loss, fluctuating network connections, and extreme temperatures to assess system performance and resilience. Additionally, compatibility across different hardware configurations and software versions is tested to identify inconsistencies and ensure a seamless user experience.

Usability testing focuses on how easily drivers and passengers can interact with the user interfaces without distraction or confusion. Testers analyze the layout, readability, and responsiveness of UI elements, measuring factors like screen glare, font size, and icon clarity in varying lighting conditions. The goal is to create interfaces that are intuitive, requiring minimal cognitive load so drivers can stay focused on the road.

The desire for improving automated image detection and extraction for testing systems of vehicles remains.

### SUMMARY

In one embodiment, a computer-implemented method is provided. The method includes receiving an image of a user interface of a system of a vehicle. The method further includes identifying input regions on the image of the user interface, the input regions to receive a user input of a user input type. The method further includes for each of the input regions of the image of the user interface, generating an input region image and location information. The method further includes performing a validation test on the user interface of the system of the vehicle using the input region image and the location information for each of the input regions. The method further includes updating the user interface of the system of the vehicle responsive to a result of the validation test.

In addition to one or more of the features described herein, or as an alternative, further embodiments of the method may include that the user input type is a tap input.

In addition to one or more of the features described herein, or as an alternative, further embodiments of the method may include that the location information comprises an initial coordinate for an input region, a width value that defines a width of the input region, and a height value that defines a height of the input region, the input region being one of the input regions.

In addition to one or more of the features described herein, or as an alternative, further embodiments of the method may include that the user input type is a swipe input.

In addition to one or more of the features described herein, or as an alternative, further embodiments of the method may include that the location information comprises a swipe start value that defines a swipe start coordinate for an input region, a swipe end value that defines a swipe end coordinate for the input region, a width value that defines a width of the input region, and a height value that defines a height of the input region, the input region being one of the input regions.

In addition to one or more of the features described herein, or as an alternative, further embodiments of the method may include that the location information further comprises a mid-x-axis value and a mid-y-axis value.

In addition to one or more of the features described herein, or as an alternative, further embodiments of the method may include storing the input region image and the location information for each of the input regions of the image of the user interface in a database.

In addition to one or more of the features described herein, or as an alternative, further embodiments of the method may include receiving a new image of the user interface of the system of the vehicle, identifying new input regions on the new image of the user interface, the new input regions to receive the user input of the user input type, for each of the new input regions of the new image of the user interface, generating a new input region image and new location information, and updating the database with the new input region image and the new location information for each of the new input regions of the new image of the user interface.

In addition to one or more of the features described herein, or as an alternative, further embodiments of the method may include that the system of the vehicle is selected from a group consisting of an infotainment system, a climate control system, and a navigation system.

In addition to one or more of the features described herein, or as an alternative, further embodiments of the method may include that the validation test simulates a plurality of user inputs to the user interface using the input region image and the location information for each of the input regions.

In another embodiment, a processing system is provided. The processing system includes a memory having computer readable instructions and a processing device for executing the computer readable instructions, the computer readable instructions controlling the processing system to perform operations. The operations include receiving an image of a user interface of a vehicle system of a vehicle. The operations further include identifying input regions on the image of the user interface, the input regions to receive a user input. The operations further include for each of the input regions of the image of the user interface, generating an input region image and location information. The operations further include performing a validation test on the user interface of an infotainment system of the vehicle using the input region image and the location information for each of the input regions. The operations further include updating the user interface of the infotainment system of the vehicle responsive to a result of the validation test.

In addition to one or more of the features described herein, or as an alternative, further embodiments of the processing system may include that the user input is one of a first user input type or a second user input type.

In addition to one or more of the features described herein, or as an alternative, further embodiments of the processing system may include that the first user input type is a tap input.

In addition to one or more of the features described herein, or as an alternative, further embodiments of the processing system may include that the location information comprises an initial coordinate for an input region, a width value that defines a width of the input region, and a height value that defines a height of the input region, the input region being one of the input regions.

In addition to one or more of the features described herein, or as an alternative, further embodiments of the processing system may include that the second user input type is a swipe input.

In addition to one or more of the features described herein, or as an alternative, further embodiments of the processing system may include that the location information comprises a swipe start value that defines a swipe start coordinate for an input region, a swipe end value that defines a swipe end coordinate for the input region, a width value that defines a width of the input region, and a height value that defines a height of the input region, the input region being one of the input regions.

In addition to one or more of the features described herein, or as an alternative, further embodiments of the processing system may include that the operations further include storing the input region image and the location information for each of the input regions of the image of the user interface in a database.

In addition to one or more of the features described herein, or as an alternative, further embodiments of the processing system may include that the operations further include receiving a new image of the user interface of the vehicle system of the vehicle, identifying new input regions on the new image of the user interface, the new input regions to receive the user input of the user input type for each of the new input regions of the new image of the user interface, generating a new input region image and new location information, updating the database with the new input region image and the new location information for each of the new input regions of the new image of the user interface.

In addition to one or more of the features described herein, or as an alternative, further embodiments of the processing system may include that the validation test simulates a plurality of user inputs to the user interface using the input region image and the location information for each of the input regions.

In another embodiment a computer program product is provided. The computer program product includes a set of one or more computer-readable storage media and program instructions, collectively stored in the set of one or more computer-readable storage media, for causing a processor set to perform computer operations. The computer operations include receiving an image of a user interface of a system of a vehicle. The computer operations further include identifying input regions on the image of the user interface, the input regions to receive a user input of a user input type. The computer operations further include for each of the input regions of the image of the user interface, generating an input region image and location information. The computer operations further include performing a validation test on the user interface of the system of the vehicle using the input region image and the location information for each of the input regions. The computer operations further include updating the user interface of the system of the vehicle responsive to a result of the validation test. The computer operations further include storing the input region image and the location information for each of the input regions of the image of the user interface in a database. The computer operations further include receiving a new image of the user interface of the system of the vehicle. The computer operations further include identifying new input regions on the new image of the user interface, the new input regions to receive the user input of the user input type. The computer operations further include for each of the new input regions of the new image of the user interface, generating a new input region image and new location information. The computer operations further include updating the database with the new input region image and the new location information for each of the new input regions of the new image of the user interface.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1A illustrates a vehicle with a vehicle system and a display according to one or more embodiments;

FIG. 1B illustrates a processing system for automated image detection and extraction for testing the vehicle system of FIG. 1A according to one or more embodiments;

FIG. 2 illustrates a flow diagram of a method for automated image detection and extraction for testing systems of vehicles according to one or more embodiments;

FIG. 3 illustrates an image of a user interface for the vehicle system of FIG. 1A according to one or more embodiments;

FIG. 4 illustrates input region images associated with input regions of the image of FIG. 3 according to one or more embodiments; and

FIG. 5 illustrates a block diagram of a processing system for intelligent automatic start/stop for vehicle engines according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., a charging controller as further described herein) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein relates to automated image detection and extraction for testing systems of vehicles.

In the realm of modern vehicle systems, particularly those equipped with infotainment displays or other displays for presenting information to drivers/passengers of vehicles, the validation process for ensuring user interface usability and functionality is an important task. This process, known as vehicle system testing, often involves manual operations, such as capturing screenshots, cropping images, extracting data, and documenting results for each iteration of the user interfaces. These tasks are labor-intensive and prone to error, which can lead to inconsistencies and inefficiencies in the testing process, especially between multiple versions of software being tested.

The desire for a more streamlined and automated approach to user interface validation is evident, as current approaches do not adequately address the demands of rapid software iteration and deployment in the automotive industry. For example, existing approaches for vehicle testing, including user interface validation, often rely on manual intervention, which is time-consuming. The lack of built-in capabilities for automated display quality assessment in widely used software platforms exacerbates these challenges. As a result, testing and validation teams resort to using image editing software and manual data entry to perform necessary tasks, which can lead to delays. Furthermore, these approaches do not effectively simulate real-world user interactions with the display, potentially overlooking significant usability issues that could impact the end-user experience.

One or more embodiments described herein address these and other shortcomings by introducing an automated image detection and extraction tool designed to enhance vehicle system testing, including user interface testing and validation, for vehicle systems. One or more embodiments automates the detection of user interface elements and the extraction of relevant display properties, such as dimensions and coordinates, from regions of interest (ROIs), referred to as “input regions,” on the user interfaces. According to one or more embodiments, artificial intelligence and machine learning techniques are used to provide a scalable and efficient solution for real-time evaluation of vehicle user interfaces, simulating real customer interactions to ensure that the vehicle system testing process accurately reflects how users engage with the vehicle system. One or more embodiments described herein not only reduces the manual effort required for validation but also improves the accuracy and reliability of the results, particularly between different versions of software running on the vehicle system being tested, thereby enhancing the quality of the software and the user experience.

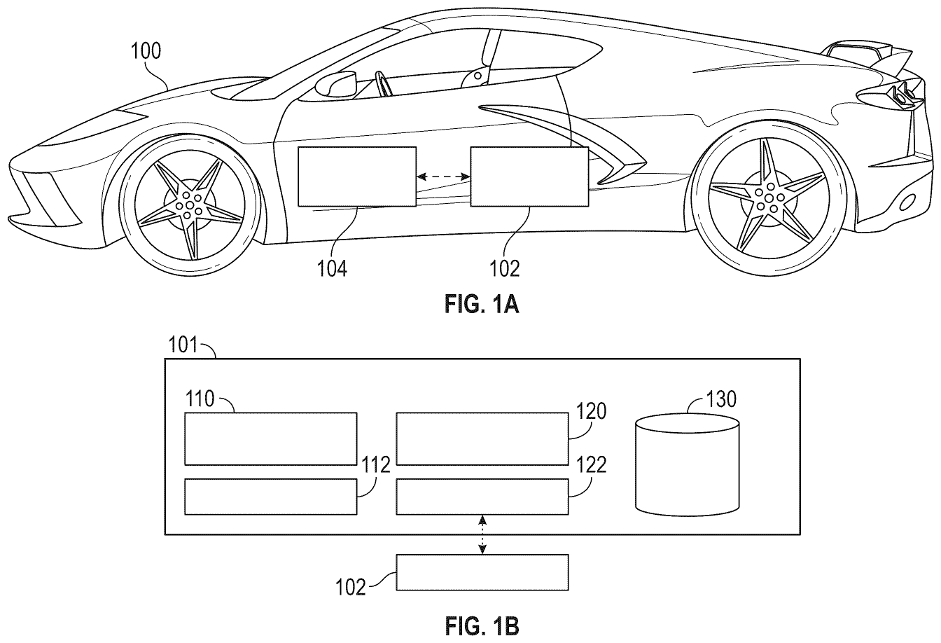

FIG. 1A shows a vehicle 100 with a vehicle system 102 and a display 104 according to one or more embodiments. The vehicle 100 can be a car, a truck, a van, a bus, a motorcycle, a boat, or any other type of automobile. According to an embodiment, the vehicle 100 is a hybrid electric vehicle, such as a plug-in hybrid electric vehicle (PHEV) partially or wholly powered by electrical power. A battery (not shown) is used to provide electrical power to components of the vehicle 100, such as an electric motor (not shown), electrical components (not shown), and/or the like, including combinations and/or multiples thereof. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

The vehicle system 102 is located within the vehicle and is responsible for performing a specific function within the vehicle 100. A vehicle system is a collection of interconnected components and subsystems within a vehicle that work together to perform specific functions, contributing to the overall operation and user experience of the vehicle. Vehicle systems encompass mechanical, electrical, and software elements, coordinating to control various aspects of the performance and functionality of the vehicle. Examples of vehicle systems include: a powertrain system, which manages engine and transmission functions; a braking system, responsible for vehicle deceleration and safety; an infotainment system, which provides navigation, media, and communication features through user interfaces; a climate control system, which provides heating and cooling functionality within a cabin of the vehicle; and/or the like, including combinations and/or multiples thereof.

The display 104 presents user interfaces that allow drivers and passengers to interact with various vehicle systems, such as the vehicle system 102. The display 104 provides visual feedback and touch-based controls for functions like navigation, climate settings, entertainment, and safety features. The display 104 may support multiple input methods, such as touch, voice commands, or physical dials, enabling users to control vehicle system 102 intuitively and easily. By integrating real-time data from sensors and system components, the display helps users monitor vehicle status, receive alerts, and make informed decisions while on the road. The display 104 can be any suitable device or screen for displaying information, images, data, interfaces of applications, and/or the like, including combinations and/or multiples thereof. According to one or more embodiments, the display 104 is a light-emitting diode (LED) display, liquid crystal display (LCD) display, organic light-emitting diode (OLED) display, active-matrix organic light-emitting diode (AMOLED) display, micro light-emitting diode (MicroLED) display, and/or the like, including combinations and/or multiples thereof.

The arrow between the vehicle system 102 and the display 104 indicate the flow of data/information/user interfaces between the vehicle system 102 and the display 104, highlighting the interaction between these components. This setup enables the display 104 to display user interfaces to a driver or passenger of the vehicle and to receive inputs via the display 104 to control the vehicle system 102.

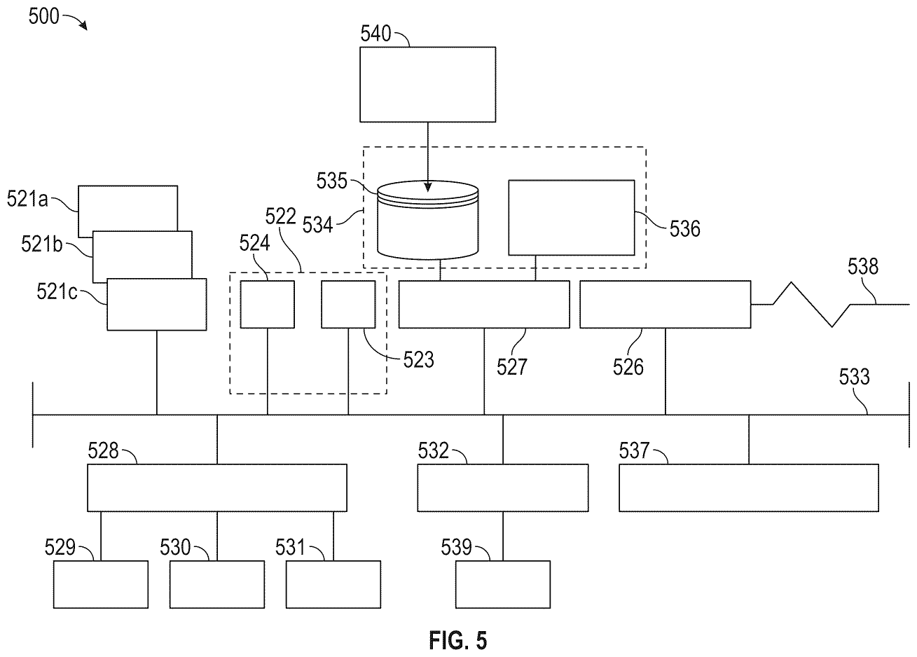

FIG. 1B illustrates a processing system 101 for testing the vehicle system 102 of FIG. 1A according to one or more embodiments. The processing system 101 includes a processing device 110, a memory 112, a detection and extraction engine 120, a testing engine 122, and a database 130. According to one or more embodiments, the processing system 101 is an example of a “controller” as described herein. It should be appreciated that the processing system 101 can be any device suitable for automated image detection and extraction for testing the vehicle system 102 of the vehicle 100. For example, the processing system 101 can be a device implemented in or otherwise associated with the vehicle 100, such as an electronic control unit (ECU) (also referred to as an electronic control module). As another example, the processing system 101 can be a smartphone, tablet computer, laptop computer, desktop computer, wearable computing device, and/or the like, including combinations and/or multiples thereof. According to one or more embodiments, the features and functionality of the detection and extraction engine 120 and/or the testing engine 122 can be implemented as processor-executable instructions (e.g., instructions executable by the processing device 110) stored on a computer readable storage medium (e.g., the memory 112). As yet another example, the processing system 101 can be the processing system 500 of FIG. 5 and/or can include one or more components of the processing system 500 of FIG. 5.

The processing device 110 is responsible for executing instructions and managing the overall operation of the processing system 101. The processing device 110 can be any suitable processing circuitry for executing instructions and processing data. For example, the processing device 110 can be a microcontroller, microprocessor, application-specific integrated circuit (ASIC), or any other type of processing unit capable of handling the computational demands of the processing system 101. The processing device 110 is an example of one or more of the processing devices 521 of FIG. 5, as described in more detail herein.

The memory 112 stores data (e.g., data about the vehicle system 102), computer-readable instructions, and algorithms useful for operation of the processing system 101. This may include real-time data processing, historical data analysis, and storage of firmware or software programs. The memory 112 is any suitable device for storing data, such as data from our about the vehicle system 102, and/or instructions. For example, the memory 112 can be a combination of volatile memory (e.g., random access memory) and non-volatile memory (e.g., read-only memory, flash memory). The memory 112 is an example of one or more of the system memory 522, the random access memory 523, and/or the read-only memory 524 of FIG. 5, as described in more detail herein.

The detection and extraction engine 120 is responsible for performing automated image detection and extraction for testing the vehicle system 102 of the vehicle 100. According to one or more embodiments, the detection and extraction engine 120 implements machine learning techniques to accurately detects input regions on the user interface, such as areas designated for user interactions like “taps” and “swipes.” By employing artificial neural networks, the detection and extraction engine 120 can learn and adapt to various patterns and criteria, ensuring precise identification of these regions. Once identified, the detection and extraction engine 120 generates input region images and extracts location information, including coordinates and dimensions, which are used for subsequent validation testing. This process not only reduces manual effort but also enhances the accuracy and reliability of the validation results.

According to one or more embodiments, the detection and extraction engine 120 supports manual selection of the input regions. For example, the detection and extraction engine 120 can utilize a function that detects mouse or other input device events as a user draws box(es) on regions of interest that represent the input regions. For example, when a left mouse button is pressed, the detection and extraction engine 120 records the starting coordinates of the box (which represents the input region); as the mouse moves while the button is depressed, the box is dynamically drawn on a copy of the image, allowing the user to see the box being created in real-time; when the left mouse button is release, the final box is drawn on the image and the box properties are recorded. Other input techniques can be used in other embodiments to identify the input region of the image of the user interface.

According to one or more embodiments, the detection and extraction engine 120 can also utilize a function that extracts box properties and generates and saves input region image and location information for the boxes (e.g., input regions). For example, when extracting box properties based on the drawn boxes, the location information can be multiplied by a scaling factor to revert back to an original image size. The box properties can be used to identify and crop images, which are input region images. According to one or more embodiments, a directory or dictionary is created where a “key” is stored as a path to a particular input region image and a “value” is stored and associated with the key such that the value represents the location information for the input region. According to one or more embodiments, the input region images can be saved with any suitable file name, which may be set or renamed by a user.

According to one or more embodiments, the detection and extraction engine 120 implements machine learning techniques to detect and extract images of user interfaces of the vehicle system 102. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”), which may be implemented by the detection and extraction engine 120 to perform automated image detection and extraction for testing the vehicle system 102 of the vehicle 100.

In one or more embodiments, machine learning functionality can be implemented using an artificial neural network (ANN) having the capability to be trained to perform a function. In machine learning and cognitive science, ANNs are a family of statistical learning models inspired by the biological neural networks in nature. ANNs can be used to estimate or approximate systems and functions that depend on a large number of inputs. Convolutional neural networks (CNN) are a class of deep, feed-forward ANNs that are particularly useful at tasks such as, but not limited to, analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for engine start/stop determination is defined by a set of input neurons that can be activated by data (e.g., images or pixels of the images) of user interfaces of the vehicle system 102. After being weighted and transformed by a function determined by the network's designer, the activation of these input neurons are then passed to other downstream neurons, which are often referred to as “hidden” neurons. This process is repeated until an output neuron is activated. The activated output neuron is a predicted input region on the images of the user interfaces of the vehicle system 102.

With continued reference to FIG. 1B, the testing engine 122 is responsible for testing the vehicle system 102 using the input region image and the location information for each of the input regions from the detection and extraction engine 120.

The testing engine 122 conducts validation tests to assess the functionality and responsiveness of the user interface, simulating various user interactions to ensure the system performs as expected under different conditions. By accurately replicating user inputs, the testing engine 122 can identify discrepancies or issues that may arise during actual use of the vehicle system 102, providing valuable insights into the user interface's performance. The testing engine 122 provides the ability to simulate real-world scenarios, which allows the testing engine 122 to test the interface's resilience and adaptability, ensuring that any potential problems are addressed before deployment. Through this rigorous testing process, the testing engine 122 contributes to enhancing the quality and reliability of the vehicle's user interface, ultimately improving the functionality of the vehicle system 102, improving the user experience, and ensuring that the vehicle system 102 meets the desired standards and expectations.

The database 130 functions as a repository for storing information for testing the vehicle system 102, such as images of user interfaces of vehicle systems being tested, input region images and location information for input regions that are identified on the images of the user interfaces, and/or the like, including combinations and/or multiples thereof. The database 130 is designed to facilitate efficient retrieval and comparison of data, enabling the processing system 101 to perform validation tests with a high degree of accuracy and consistency. By maintaining a structured collection of images and metadata (e.g., location information for input regions that are identified on the images of the user interfaces), the database 130 supports the continuous updating and refinement of the validation/testing process. The database 130 allows for the storage of both initial and new input region data, ensuring that the processing system 101 can adapt to changes in user interfaces over time, such when a new version is released or being tested. This adaptability is useful for keeping the validation process aligned with software updates and modifications in vehicle systems of the vehicle (e.g., vehicle system 102 of the vehicle 100). Additionally, the database 130 provides a foundation for machine learning models to be trained and fine-tuned, leveraging the stored data to enhance the ability to detect and analyze user interface elements.

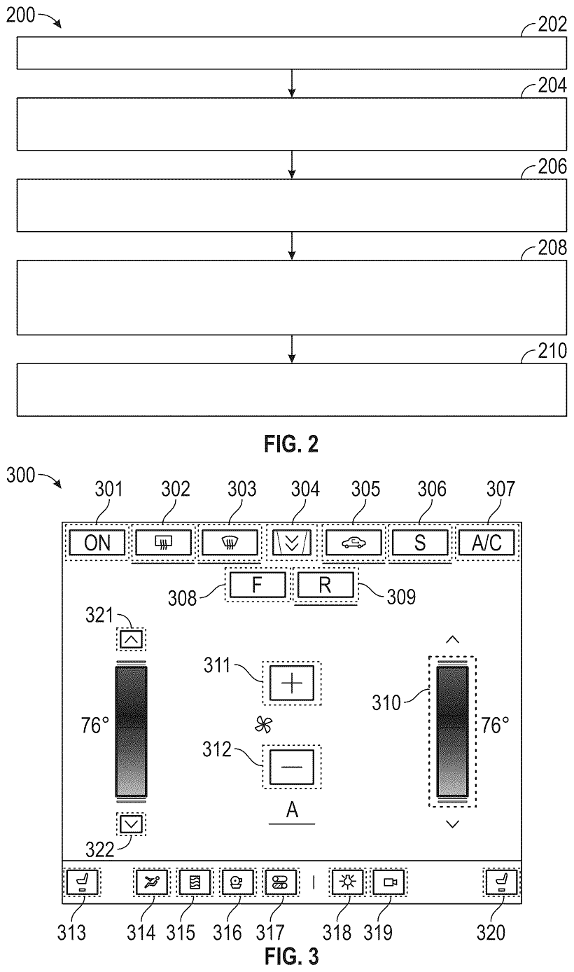

FIG. 2 illustrates a flow diagram of a method 200 for automated image detection and extraction for testing systems of vehicles according to one or more embodiments. The method 200 can be implemented using any suitable system or device. For example, the method 200, and its operations, can be implemented using the processing system 101 of FIG. 1B, by the processing system 500 of FIG. 5, and/or the like, including combinations and/or multiples thereof. The method 200 provides for efficient and reliable operation of the vehicle 100 by testing the vehicle system 102. The method 200 is now described with reference to at least portions of FIGS. 1A and 1B but is not so limited.

The method 200, as illustrated in FIG. 2, begins with operation 202, which involves receiving (e.g., by the processing system 101) an image of a user interface of a system (e.g., vehicle system 102) of a vehicle (e.g., vehicle 100). The operation 202 sets the foundation for subsequent operations by capturing the visual representation of the user interface(s) that will be analyzed. The image can be obtained from various sources, such as a live feed from the vehicle's display (e.g., display 104) or a stored image from a database (e.g., the database 130). This operation ensures that the processing system 101 has the data (e.g., images) to proceed with identifying and analyzing input regions on the user interface. FIG. 3 illustrates an image 300 of a user interface for the vehicle system 102 of FIG. 1A according to one or more embodiments. In this example, the image 300 depicts a user interface of a climate control system, but the embodiments described herein are not limited to climate control systems and are instead applicable to a variety of vehicle systems.

With continued reference to FIG. 2, following the receipt of the image, at operation 204 the detection and extraction engine 120 identifies input regions on the image of the user interface. These input regions are designated areas on the interface that are intended to receive user inputs, such as taps or swipes. According to one or more embodiments, with reference to FIG. 3, the detection and extraction engine 120 detects input regions 301, 302, 303, 304, 305, 306, 307, 308, 309, 310, 311, 312, 313, 314, 315, 316, 317, 318, 319, 320, 321, 322. According to one or more embodiments, the input regions have bounding boxes associated therewith. Each of the input regions 301-322 corresponds to a different function that can be performed by the climate control system. For example, the input region 301 is used to enable/disable (e.g., turn “ON” or turn “OFF”) the climate control system and represents a tap input type user input (e.g., the user “taps” the input region 301 to enable or disable the climate control system). As another example, the input region 310 is used to increase a cabin temperature, which represents a swipe type user input (e.g., the user “swipes” a finger up/down on the input region 310 to increase or decrease the cabin temperature). The identification at operation 204 may utilize machine learning algorithms to accurately identify the input regions based on predefined criteria or patterns, for example. By identifying these input regions, the processing system 101 can effectively simulate user interactions with the interface of the vehicle system 102.

In operation 206, for each of the identified input regions, the detection and extraction engine 120 generates an input region image and location information for the input region image relative to the image. This involves creating a separate image for each input region and extracting its location details, such as coordinates and dimensions.

For “tap” type user inputs, the location information may include an initial coordinate for an input region, a width value that defines a width of the input region, and a height value that defines a height of the input region, the input region being one of the input regions. According to one or more embodiments, the location information may be generated as code or pseudo code, such as according to the following non-limiting example:
Input_Region_Name={‘click_coordinates’: (822, 246), ‘original_coordinates’: (690, 192), ‘width’: 264, ‘height’: 108}.

For “swipe” type user inputs, the location information may include a swipe start value that defines a swipe start coordinate for an input region, a swipe end value that defines a swipe end coordinate for the input region, a width value that defines a width of the input region, and a height value that defines a height of the input region, the input region being one of the input regions. According to one or more embodiments, for “swipe” type user inputs, the location information may further include mid-x-axis and mid-y-axis values in the location information. This operation ensures that the system has precise data for each input region, which is essential for accurate validation testing. According to one or more embodiments, the location information may be generated as code or pseudo code, such as according to the following non-limiting example:
Input_Region_Name={‘swipe_start’: (172, 608), ‘swipe_end’: (728, 742), ‘width’: 556, ‘height’: 134, ‘mid_x’: 450, ‘mid_y’: 672}.
   In the above representation, “‘swipe_start’: (172, 608)” represents the starting coordinates of the swipe (e.g., the top-left corner of the swipe area), where the first value “172” indicates the starting x-coordinate (horizontal position), and the second value “608” indicates the starting y-coordinate (vertical position). Similarly, “‘swipe_end’: (728, 742)” represents the ending coordinates of the swipe (e.g., the bottom-right corner of the ending area), where the first value “728” is the x-coordinate where the swipe ends (horizontal position), and the second value “742” is the y-coordinate where the swipe ends (vertical position). The “‘width’: 556” represents the width of the area or box being considered, measured horizontally in pixels. The “‘height’: 134” represents the height of the area or box being considered, measured vertically in pixels. Further, “‘mid_x’: 450” value represents the x-coordinate of the midpoint of the box (horizontally), and “‘mid_y’: 672” represents the y-coordinate of the midpoint of the box (vertically).

The dimensions (“width”, “height”) are used to calculate the relative positions of the swipe, considering percentages of the width and height. The midpoints (“mid_x”, “mid_y”) serve as reference points, particularly for swipe types that are centered around the middle of the box. Swipe start and swipe end (“swipe_start”, “swipe_end”) determine the starting point and the ending point of the swipe. Database values are used to dynamically calculate the swipe movement from the starting point and adjusting the ending point accordingly.

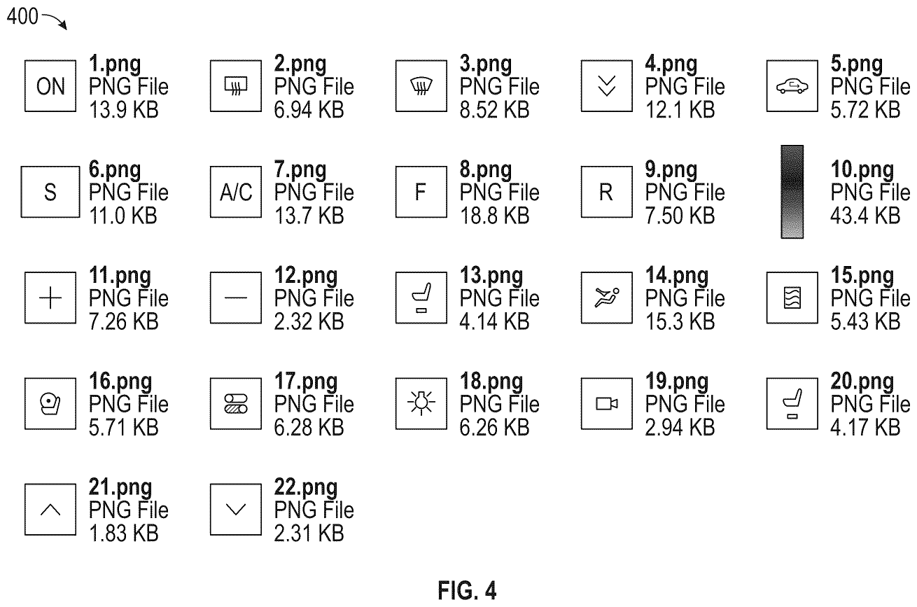

FIG. 4 illustrates input region images associated with input regions of the image 300 of FIG. 3 according to one or more embodiments. In this example, twenty-two separate input region images are shown and are labeled with consecutive file names: 1.png, 2.png, 3.png, . . . , 21.png, 22.png, where the input region image 1.png corresponds to input region 301, the input region image 2.png corresponds to input region 302, and so forth. Although portable network graphics (PNG) files are shown in this example, other file formats can be used in other embodiments, such as joint photographic experts group (JPEG), graphics interchange format (GIF), tagged image file format (TIFF), bitmap image file (BMP), and/or the like, including combinations and/or multiples thereof.

With continued reference to FIG. 2, operation 208 involves the testing engine 122 performing a validation test on the user interface of the vehicle system 102 of the vehicle 100 using the input region image and the location information for each of the input regions. Operation 208 is useful for assessing the functionality and responsiveness of the user interface of the vehicle system 102. The validation test simulates various user inputs to evaluate how the user interface responds under different conditions. By using the input region images and location information, the testing engine 122 can accurately replicate user interactions and identify any discrepancies or issues that may arise during actual use.

Operation 210 updates the user interface of the system of the vehicle responsive to a result of the validation test. This operation ensures that any identified issues or improvements are addressed, leading to an enhanced user experience. The update process may involve modifying the interface layout, adjusting input region properties, or implementing software patches to resolve detected problems. This operation is useful for maintaining the quality and reliability of the user interface for the vehicle system 102 of the vehicle 100, ensuring that the user interface meets the desired standards and user expectations.

According to one or more embodiments, the method 200 may include storing the input region image and location information for each of the input regions in a database, such as the database 130. This allows for efficient retrieval and comparison of data in future validation tests, such as when an updated user interface is tested. For example, when an updated user interface is tested, the detection and extraction engine 120 can compare the prior version with the new version to detect changes and then can identify input regions that may be new or modified and can create input region images and location information for those new or modified input regions without the need to recreate such information for unchanged input regions. That is, according to one or more embodiments, the method 200 can receive a new image of the user interface, identify new input regions, generate new input region images and location information, and update the database 130 accordingly. This continuous updating process ensures that the processing system 101 remains current with any changes or updates to the user interface, providing a robust and adaptable solution for vehicle system validation.

Additional processes also may be included, and it should be understood that the processes depicted in FIG. 2 represent illustrations, and that other processes may be added, or existing processes may be removed, modified, or rearranged without departing from the scope of the present disclosure. It should also be understood that the processes depicted in FIG. 2 may be implemented as programmatic instructions stored on a non-transitory computer-readable storage medium that, when executed by a processor (e.g., the processing device 110 of FIG. 1B, the processor(s) 521 of FIG. 5, and/or the like, including combinations and/or multiples thereof) of a computing system (e.g., the processing system 101 of FIGS. 1A and 1B, the processing system 500 of FIG. 5, and/or the like, including combinations and/or multiples thereof), cause the processor to perform the processes described herein.

One or more embodiments offer significant technical benefits. For example, one or more embodiments described herein offer significant benefits by automating the validation process for vehicle user interfaces, which traditionally involves manual operations prone to error. By leveraging machine learning and artificial intelligence, one or more embodiments enhances the accuracy and efficiency of detecting and extracting user interface elements, significantly reducing the time and resources used for validation testing. This automation not only streamlines the process but also ensures more consistent and reliable results, ultimately improving the quality of the software and the user experience. One or more embodiments provides the ability to simulate real-world user interactions, which further ensures that the validation process accurately reflects how users engage with vehicle systems through a display of the vehicle, addressing usability issues that might otherwise be overlooked.

In terms of improvements to the functioning of the vehicle 100 and the vehicle system 102, the automated validation described herein contributes to a more robust and reliable user interface. By ensuring that the interface performs optimally under various conditions, one or more embodiments described herein enhances the overall functionality of the vehicle system 102 and/or other systems within the vehicle 100. This leads to a more intuitive and seamless user experience, allowing drivers and passengers to interact with the vehicle systems with ease and confidence. The reduction in manual effort and human error also means that software updates and iterations can be deployed more rapidly while using fewer computational resources, keeping the vehicle systems up-to-date with the latest features and improvements. As a result, the vehicle 100 and its systems, such as the vehicle system 102, benefit from increased operational efficiency and enhanced user satisfaction.

It is understood that one or more embodiments described herein is capable of being implemented in conjunction with any other type of computing environment now known or later developed. For example, FIG. 5 depicts a block diagram of a processing system 500 for implementing the techniques described herein. In accordance with one or more embodiments described herein, the processing system 500 is an example of a cloud computing node of a cloud computing environment. In examples, processing system 500 has one or more central processing units (referred to also as “processors” or “processing resources” or “processing devices”) 521a, 521b, 521c, etc. (collectively or generically referred to as processor(s) 521 and/or as processing device(s) 521). In aspects of the present disclosure, each processor 521 can include a reduced instruction set computer (RISC) microprocessor. Processors 521 are coupled to a system memory 522 and/or various other components via a system bus 533. The system memory 522 can include one or more temporary and/or persistent memory devices, such as a random access memory (RAM) 523, a read-only memory (ROM) 524, and/or the like, including combinations and/or multiples thereof. The system bus 533 may include a basic input/output system (BIOS), which controls certain basic functions of processing system 500.

Further depicted are an input/output (I/O) adapter 527 and a network adapter 526 coupled to system bus 533. I/O adapter 527 may be a small computer system interface (SCSI) adapter that communicates with a hard disk 535 and/or a storage device 536 or any other similar component. I/O adapter 527, hard disk 535, and storage device 536 are collectively referred to herein as mass storage 534. Operating system 540 for execution on processing system 500 may be stored in mass storage 534. The network adapter 526 interconnects system bus 533 with an outside network 538 enabling processing system 500 to communicate with other such systems.

A display (e.g., a display monitor) 539 is connected to system bus 533 by display adapter 532, which may include a graphics adapter to improve the performance of graphics intensive applications and a video controller. In one aspect of the present disclosure, adapters 526, 527, and/or 532 may be connected to one or more I/O buses that are connected to system bus 533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 533 via user interface adapter 528 and display adapter 532. A keyboard 529, mouse 530, and speaker 531 may be interconnected to system bus 533 via user interface adapter 528, which may include, for example, a Super I/O chip integrating multiple device adapters into a single integrated circuit.

In some aspects of the present disclosure, processing system 500 includes a graphics processing unit (GPU) 537. Graphics processing unit 537 is a specialized electronic circuit designed to manipulate and alter memory to accelerate the creation of images in a frame buffer intended for output to a display. In general, graphics processing unit 537 is very efficient at manipulating computer graphics and image processing and has a highly parallel structure that makes it more effective than general-purpose CPUs for algorithms where processing of large blocks of data is done in parallel.

Thus, as configured herein, processing system 500 includes processing capability in the form of processors 521, storage capability including the system memory 522 and mass storage 534, input means such as keyboard 525 and mouse 530, and output capability including speaker 531 and display 539. In some aspects of the present disclosure, a portion of system memory 522 and mass storage 534 collectively store the operating system 540 to coordinate the functions of the various components shown in processing system 500.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method comprising:
receiving an image of a user interface of a system of a vehicle;
identifying input regions on the image of the user interface, the input regions to receive a user input of a user input type;
for each of the input regions of the image of the user interface, generating an input region image and location information;
performing a validation test on the user interface of the system of the vehicle using the input region image and the location information for each of the input regions; and
updating the user interface of the system of the vehicle responsive to a result of the validation test.

2. The computer-implemented method of claim 1, wherein the user input type is a tap input.

3. The computer-implemented method of claim 2, wherein the location information comprises an initial coordinate for an input region, a width value that defines a width of the input region, and a height value that defines a height of the input region, the input region being one of the input regions.

4. The computer-implemented method of claim 1, wherein the user input type is a swipe input.

5. The computer-implemented method of claim 4, wherein the location information comprises a swipe start value that defines a swipe start coordinate for an input region, a swipe end value that defines a swipe end coordinate for the input region, a width value that defines a width of the input region, and a height value that defines a height of the input region, the input region being one of the input regions.

6. The computer-implemented method of claim 5, wherein the location information further comprises a mid-x-axis value and a mid-y-axis value.

7. The computer-implemented method of claim 1, further comprising storing the input region image and the location information for each of the input regions of the image of the user interface in a database.

8. The computer-implemented method of claim 7, further comprising:
receiving a new image of the user interface of the system of the vehicle;
identifying new input regions on the new image of the user interface, the new input regions to receive the user input of the user input type;
for each of the new input regions of the new image of the user interface, generating a new input region image and new location information; and
updating the database with the new input region image and the new location information for each of the new input regions of the new image of the user interface.

9. The computer-implemented method of claim 1, wherein the system of the vehicle is selected from a group consisting of an infotainment system, a climate control system, and a navigation system.

10. The computer-implemented method of claim 1, wherein the validation test simulates a plurality of user inputs to the user interface using the input region image and the location information for each of the input regions.

11. A processing system comprising:
a memory comprising computer readable instructions; and
a processing device for executing the computer readable instructions, the computer readable instructions controlling the processing system to perform operations comprising:
receiving an image of a user interface of a vehicle system of a vehicle;
identifying input regions on the image of the user interface, the input regions to receive a user input;
for each of the input regions of the image of the user interface, generating an input region image and location information;
performing a validation test on the user interface of an infotainment system of the vehicle using the input region image and the location information for each of the input regions; and
updating the user interface of the infotainment system of the vehicle responsive to a result of the validation test.

12. The processing system of claim 11, wherein the user input is one of a first user input type or a second user input type.

13. The processing system of claim 12, wherein the first user input type is a tap input.

14. The processing system of claim 13, wherein the location information comprises an initial coordinate for an input region, a width value that defines a width of the input region, and a height value that defines a height of the input region, the input region being one of the input regions.

15. The processing system of claim 12, wherein the second user input type is a swipe input.

16. The processing system of claim 15, wherein the location information comprises a swipe start value that defines a swipe start coordinate for an input region, a swipe end value that defines a swipe end coordinate for the input region, a width value that defines a width of the input region, and a height value that defines a height of the input region, the input region being one of the input regions.

17. The processing system of claim 11, the operations further comprising storing the input region image and the location information for each of the input regions of the image of the user interface in a database.

18. The processing system of claim 17, the operations further comprising:
receiving a new image of the user interface of the vehicle system of the vehicle;
identifying new input regions on the new image of the user interface, the new input regions to receive the user input of the user input type for each of the new input regions of the new image of the user interface, generating a new input region image and new location information; and
updating the database with the new input region image and the new location information for each of the new input regions of the new image of the user interface.

19. The processing system of claim 11, wherein the validation test simulates a plurality of user inputs to the user interface using the input region image and the location information for each of the input regions.

20. A computer program product comprising:
a set of one or more computer-readable storage media;
program instructions, collectively stored in the set of one or more computer-readable storage media, for causing a processor set to perform computer operations comprising:
receiving an image of a user interface of a system of a vehicle;
identifying input regions on the image of the user interface, the input regions to receive a user input of a user input type;
for each of the input regions of the image of the user interface, generating an input region image and location information;
performing a validation test on the user interface of the system of the vehicle using the input region image and the location information for each of the input regions;
updating the user interface of the system of the vehicle responsive to a result of the validation test;
storing the input region image and the location information for each of the input regions of the image of the user interface in a database;
receiving a new image of the user interface of the system of the vehicle;
identifying new input regions on the new image of the user interface, the new input regions to receive the user input of the user input type;
for each of the new input regions of the new image of the user interface, generating a new input region image and new location information; and
updating the database with the new input region image and the new location information for each of the new input regions of the new image of the user interface.
